(19) United States
(12) Patent Application Publication
(10) Pub. No.: US 2007/0216368 A1
(43) Pub. Date: Sep. 20, 2007

(54) Cell balancing system

(75) Inventors: Lance Chandler, Toutle, WA (US); Raymond Goodrich, Saugus, CA (US); David Sorlien, Escondido, CA (US)

Correspondence Address: WALLACE G. WALTER, 5726 CLARENCE AVE, ALEXANDRIA, VA, 22311-1008, US

(73) Assignee: Poweready

(21) Appl. No.: 10/779,324

(22) Filed: Feb. 13, 2004

Related U.S. Application Data
(60) Provisional application No. 60/447,475, filed on Feb. 13, 2003.

(51) Int. Cl. H02J 7/00

(52) U.S. Cl. 320/136

(57) ABSTRACT

Referring to FIG. 1, a cell balancing system of the present invention is shown and generally designated 100. System 100 includes a number of battery cells 102 in electrical communication with a safety circuit 104. In a preferred embodiment, the safety circuit 104 is included in an application specific semiconductor (ASIC) and provides an input/output channel 106 that includes, for example, Vbat(+), Clock, Data, Return, and Vbat(−) signals for use by a device which incorporates the battery. It is to be appreciated that I/O channel 106 may be of any type, generic or proprietary, and may have any number of communication protocols as is known in the art.

### RELATED APPLICATION

This application claims the benefit of priority to U.S. Provisional Patent Application No. 60/447,475 filed Feb. 13, 2003, and currently co-pending.

### FIELD OF THE INVENTION

The present invention relates generally to a method of cell balancing in batteries. More specifically, the present invention pertains to a method of balancing charging levels for individual batteries in a multi-cell battery pack, including all Lithium chemistry batteries.

### BACKGROUND OF THE INVENTION

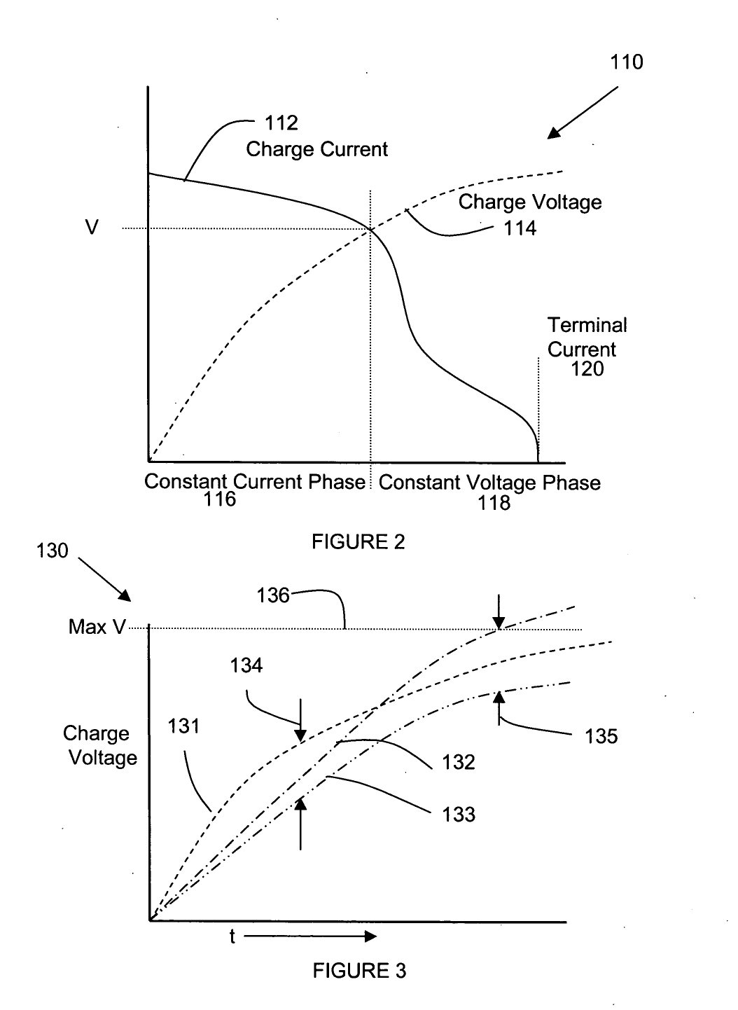

FIG. 2 presents a graph of a typical charging curve for a lithium chemistry battery cell, and is generally designated 110. Graph 110 includes a charge current plot 112 and a charge voltage plot 114. Typical charging methods for lithium ion batteries includes a constant current phase 116 wherein the charge current provided to the cell by a charger (not shown) is maintained at a constant level. Once the cell reaches a predetermined voltage, the charger changes to a constant voltage phase 118 until the current reaches a terminal, or minimal, level at point 120.

While FIG. 2 depicts a typical charging profile for a lithium cell battery, it is to be appreciated that due to manufacturing techniques and distinctions in the chemistry within each battery cell, the particular charging profiles may vary from cell to cell. This variance is also due to the difference in charge/discharge cycles for each battery.

Referring to FIG. 3, a plot of voltage charging curves for a set of three batteries are shown and generally designated 130. Plot 130 includes plots for cells 131, 132, and 133 corresponding to different cells. As is seen from FIG. 3, there may be significant distinctions between the charging curve of the various cells. For instance, the difference in voltage (Δv) 134 between cells 131 and 133 may be significant, and results in the battery cells having significantly different energy capacities.

In addition to having differing charging cycles, due to the extremely critical over-voltage protections necessary for lithium batteries, a battery pack having mis-matched, or un-balanced cells results in a battery pack having a less-than-maximum charge. For instance, the difference in voltage between cells 132 and 133 at the point where one of the cells 132 reaches the maximum allowable voltage 136, results in the stopping of the charging cycle. At this point, however, cell 133 is only partially charged. This partial charging results in a battery pack having a significantly reduced charge, and thus, significantly reduced capacity and useable life.

### DESCRIPTION OF A PREFERRED EMBODIMENT

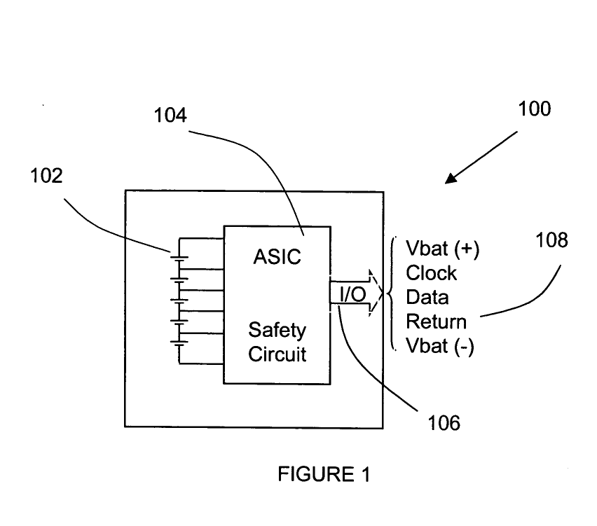

Referring to FIG. 1, a cell balancing system of the present invention is shown and generally designated 100. System 100 includes a number of battery cells 102 in electrical communication with a safety circuit 104. In a preferred embodiment, the safety circuit 104 is included in an application specific semiconductor (ASIC) and provides an input/output channel 106 that includes, for example, Vbat(+), Clock, Data, Return, and Vbat(−) signals for use by a device which incorporates the battery. It is to be appreciated that I/O channel 106 may be of any type, generic or proprietary, and may have any number of communication protocols as is known in the art.

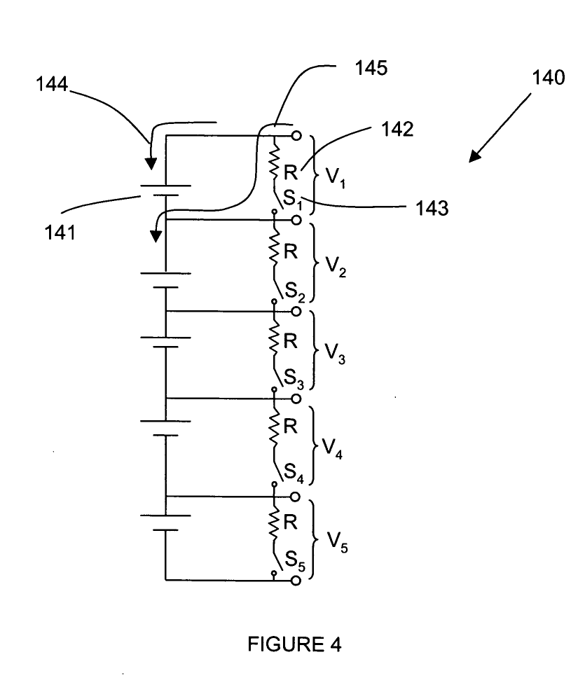

Referring now to FIG. 4, a balancing circuit incorporated into the cell balancing system of the present invention is shown and designated 140. Circuit 140 includes cells 141 in a parallel combination of a shunt resistor 142 and a switch 143 that is switchable electronically from a control signal (not shown this Figure).

In a preferred embodiment of the present invention, when charging of cell 141 is desired, switch (S₁) 143 is open, causing current 144 to flow through cell 141, thereby charging the cell 141. When charging of cell 141 is not desired, switch (S₁) 143 is closed, causing current 145 to flow through shunt resistor 142 and switch (S₁) 143, thereby bypassing cell 141. It is to be appreciated that other cells within the present invention may be bypassed in the same manner by closing the switches (S₂₋₅) closed.

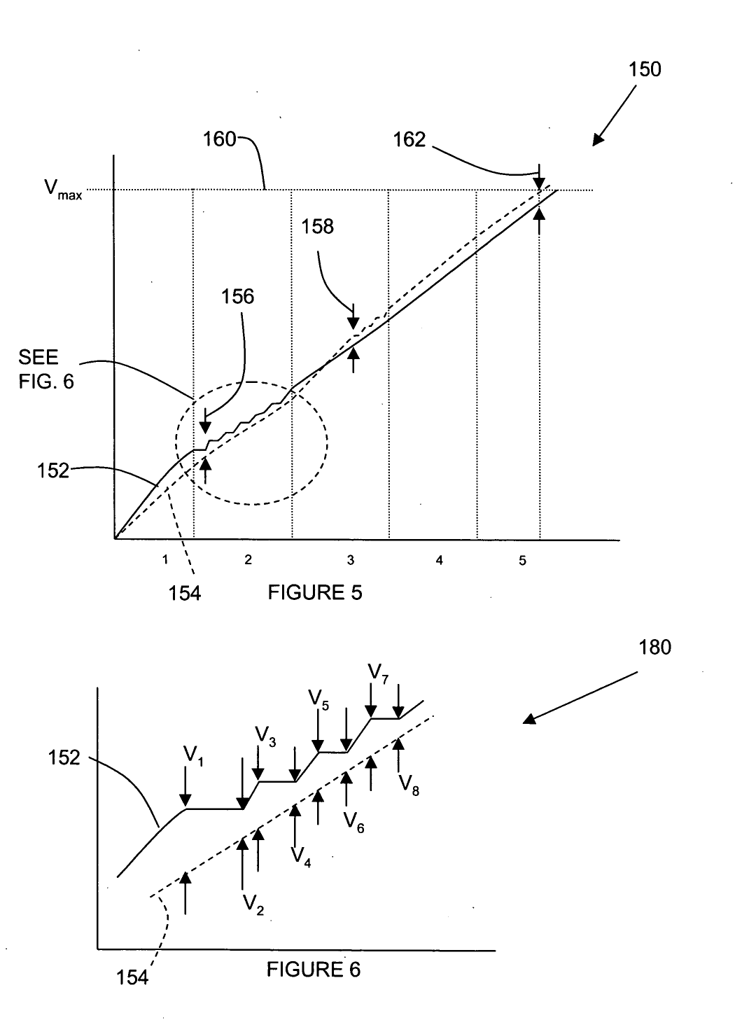

Referring to FIG. 5, a typical charging curve for two cells is shown and generally designated 150. As seen in this Figure, cells 152 and 154 may have different charging curves. Implementation of the cell balancing system of the present invention is most apparent at location 156 where the difference in voltage between cell 152 and 154 exceeds a predetermined level, such as 50 millivolts. At this point in the charging cycle, the circuit described in conjunction with FIG. 4 is implemented, and cell 152 is bypassed thereby pausing the charging of cell 152, while cell 154 continues to be charged.

FIG. 6 is an enlarged portion of FIG. 5, showing the details of the charging and bypassing of cell 154 of the present invention. When the voltage difference between cells 152 and 154 exceeds a predetermined value at point V1, the shunt resistor 142 is switched into the circuit with switch 143, shunting the charge current through path 145. Cell 154 continues to be charged while cell 152 is being shunted from the charging circuit. Once the difference in voltage between cells 152 and 153 is less than a predetermined value at point V2, such as 40 millivolts, switch 142 opens and charging current is again provided to cell 152.

The charging of cell 152 is effectively switched on and off to maintain the differences in voltages below a predetermined threshold. Table 1 below summarizes the operation of the cell balancing system of the present invention in operation.

| Voltage Point | Voltage Difference | Switch Position | Charging Mode |
|---|---|---|---|
| V1 | V1 > Vmax | Closed | Bypass |
| V2 | V2 < Vmax | Open | Charging |
| V3 | V3 > Vmax | Closed | Bypass |
| V4 | V4 < Vmax | Open | Charging |
| V5 | V5 > Vmax | Closed | Bypass |
| V6 | V6 < Vmax | Open | Charging |
| V7 | V7 > Vmax | Closed | Bypass |
| V8 | V8 < Vmax | Open | Charging |

The voltage differences that trigger the opening or closing of switch S1 may vary in order to insert a modicum of hysteresis into the charging system, and to avoid a rapid on-off switching when the voltage difference is close to the maximum voltage threshold.

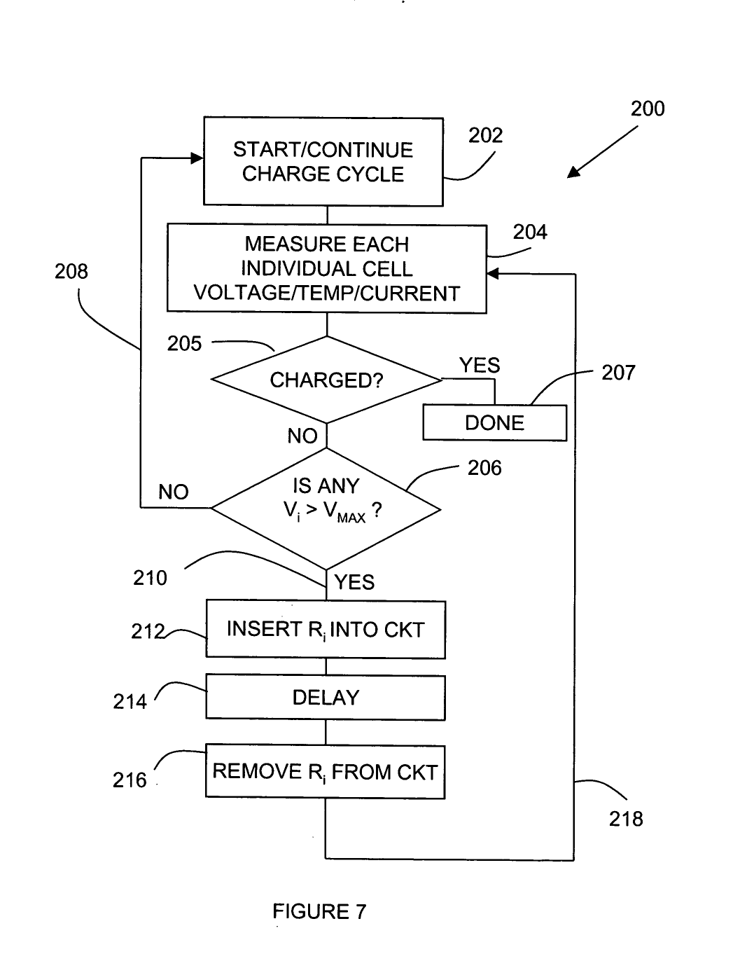

Referring to FIG. 7, a flow chart of a typical operation of the cell balancing system of the present invention, and generally designated 200. Method 200 begins with the charging cycle start in step 202. Each individual cell voltage is measured in step 204, along with other critical cell parameters, such as temperature and current. If the battery is fully charged as identified in step 205, the charging process is finished in step 207, otherwise the system proceeds to step 206. In step 206, the measured voltages for each cell are compared to the other cells, and if one or more of the cells is more than a predetermined voltage greater than its companion cell voltages, the switch is closed and a shunt resistor is placed across the over-voltage battery. This step may involve placing a shunt resistor across more than one cell at a time.

System 200 provides a delay in step 214 during which the under-voltage cells are charged and the over-voltage cells are shunted, to provide an opportunity for the balancing of the cell voltages within a battery pack. Following the delay in step 214, the switches are opened and the shunt resistors are removed from the charging circuit. Via return path 218, the cells voltages are once again measured. In the event that the battery is not charged, and the differences in cell voltages continue to exceed the threshold voltage as measured in step 206, the over-voltage cells are once again shunted for a delay period and the process repeats.

The benefit of the cell balancing system of the present invention is that the voltage of the individual cells within a battery pack are maintained within a small voltage differential, resulting in a charged battery pack having all cells within the battery fully charged to within a predetermined minimal voltage difference. Since the capacity of a battery pack is determined by the lowest-charged cell, the benefits of having a balanced charging system are significant, resulting in battery packs having 30% to 40% higher power densities.

Important characteristics of the method of cell balancing, include:
unbalanced battery capacity—fully charge due to swelling characteristics of lithium ion (8% swell)
Voltage monitoring—maintain balance between different cells
Charge accuracy per cell—fully charge each cell, not just the battery pack, cycle life of the pack
Avoid under voltage use causes metallization of cells
Continuous monitor of cell voltages
Switch R shunt in and out providing for a mean voltage between cells.
   Algorithm—used for charging the cells within the battery pack, include parameters for:
Data set for each
algorithms in a microprocessor, microcontroller, etc.
use ASIC for an embedded solution

1. A cell balancing system, comprising:
one or more battery cells;
a safety circuit in electrical communication with said battery cells;
an input/output channel for use by a device which incorporates said battery cells;
and a means for balancing the discharge of said cells.
